(19) United States
(12) Patent Application Publication
(10) Pub. No.: US 2022/0156032 A1
(43) Pub. Date: May 19, 2022

(54) SYSTEM AND METHOD FOR FEEDBACK FOR REMOTE INTERFACING OF AN ANTI-FOULING SYSTEM FOR SUBMERGED VESSELS AND STRUCTURES

(71) Applicant: WAVEARRAY ANTIFOULING SYSTEMS, LLC, Naples, FL (US)

(72) Inventors: James DiLorenzo, Naples, FL (US); Justin Mullins, Naples, FL (US); Peter Schibly, Litchfield, NH (US)

(21) Appl. No.: 17/525,886

(22) Filed: Nov. 13, 2021

Related U.S. Application Data
(60) Provisional application No. 63/113,927, filed on Nov. 15, 2020.

(51) Int. Cl. G06F 3/16; G06F 9/451; G05B 19/4155

(52) U.S. Cl. CPC G06F 3/16; G05B 2219/37337; G05B 19/4155; G06F 9/451

(57) ABSTRACT

A method of controlling an anti-fouling system, the method comprising: activating at least one transducer and at least one sensor; analyzing the at least one transducer and the at least one sensor to determine a set of features of the at least one transducer and the at least one sensor which are controllable; generating a user interface, wherein the user interface is based on the set of features of the at least one transducer and the at least one sensor; generating a sound wave from the at least one transducer based on input data; monitoring the performance of the transducer by collecting data from the at least one sensor; and providing the collected data through the user interface, wherein values outside of a predetermined range, further comprise, transmitting an indicator of the values.

### CROSS-REFERENCE TO RELATED APPLICATIONS

This application is a continuation-in-part (and claims the benefit of priority under 35 USC 120) of U.S. application No. 63/113,928, filed Nov. 15, 2020. The disclosure of the prior applications is considered part of (and is incorporated by reference in) the disclosure of this application.

### BACKGROUND OF THE INVENTION

The present invention relates to a method for preventing aquatic biological growth on submerged vessels or structures and/or biological fouling in water (e.g., fouling organisms found in ship ballast tanks), and more particularly to a remote system to monitor and control the anti-fouling system.

The settlement and growth of fouling organisms such as barnacles and algae have long plagued both commercial and recreational boaters. The colonization of submerged man-made surfaces by these organisms is referred to as “fouling” as they increase the weight and drag on the vessel thereby reducing the speed of the vessel underway. This increases fuel consumption and makes the vessel more difficult to handle, thus reducing the performance and efficiency of the vessel. In addition, fouling is prevalent and widespread on marina pilings, and other structures. On fixed structures, fouling increases weight and structural loading.

Various methods have been used to attempt to limit boat fouling, such as anti-fouling paints, the use of copper electrodes to release copper into the water and use of chlorine generation to release chlorine into the water. In general, these techniques function by releasing toxic chemicals into the water surrounding a boat thus preventing the settlement and subsequent growth of barnacles as well as other forms of marine, brackish and freshwater life. However, the use of these methods obviously creates a negative environmental impact affecting fish-life and in turn fish food and humans and poses a serious threat to the health of the world oceans and other bodies of water due to the toxicity of chemicals employed. Several states in the U.S. have now banned the use of certain anti-fouling agents and other countries of the world have joined in a similar ban.

Each of these anti-fouling methods as now practiced have problems discovered by the present inventors and resolved by their invention. As a result, many boaters have resorted to installing expensive lifts to remove their boats from the water in areas such as Florida, where year-round boating is common. For larger boats (e.g., over 35 feet), lifts are often not practical or affordable. And in many places worldwide, lifts are not commonly used due to seasonal boating activities.

In consideration of the current existing anti-fouling methods and practices, which include primarily the application of toxic bottom paints to boats and labor intensive, repetitive manual cleaning of fouled surfaces, both of which are only partially effective and provide short-term protection only, it is evident there remains the need for a system that incorporates the attributes of affordability, long-term consistent fool proof operability, dependability and effectiveness, as well as being safe for the environment.

### SUMMARY

In a first embodiment, the present invention is a method of controlling an anti-fouling system, the method comprising: activating, by one or more computing devices, at least one transducer and at least one sensor; analyzing, by one or more computing devices, the at least one transducer and the at least one sensor to determine a set of features of the at least one transducer and the at least one sensor which are controllable; generating, by one or more computing devices, a user interface, wherein the user interface is based on the set of features of the at least one transducer and the at least one sensor; generating, by one or more computing devices, a sound wave from the at least one transducer based on input data; monitoring, by one or more computing devices, the performance of the transducer by collecting data from the at least one sensor; and providing, by one or more computing devices, the collected data through the user interface, wherein values outside of a predetermined range, further comprise, transmitting, by one or more computing devices, an indicator of the values.

In a second embodiment, the present invention is a computer program product for controlling an anti-fouling system, the method comprising: the computer program product comprising a computer readable storage medium having program instructions embodied therewith, the program instructions executable by a computing device to cause the computing device to: program instructions to activate at least one transducer and at least one sensor; program instructions to analyze the at least one transducer and the at least one sensor to determine a set of features of the at least one transducer and the at least one sensor which are controllable; program instructions to generate a user interface, wherein the user interface is based on the set of features of the at least one transducer and the at least one sensor; program instructions to generate a sound wave from the at least one transducer based on input data; program instructions to monitor the performance of the transducer by collecting data from the at least one sensor; and program instructions to provide the collected data through the user interface, wherein values outside of a predetermined range, further comprise, transmitting, by one or more computing devices, an indicator of the values.

In a third embodiment, the present invention is an anti-fouling system, the method comprising: a CPU, a computer readable memory and a computer readable storage medium associated with a computing device; program instructions to activate at least one transducer and at least one sensor; program instructions to analyze the at least one transducer and the at least one sensor to determine a set of features of the at least one transducer and the at least one sensor which are controllable; program instructions to generate a user interface, wherein the user interface is based on the set of features of the at least one transducer and the at least one sensor; program instructions to generate a sound wave from the at least one transducer based on input data; program instructions to monitor the performance of the transducer by collecting data from the at least one sensor; and program instructions to provide the collected data through the user interface, wherein values outside of a predetermined range, further comprise, transmitting, by one or more

### BRIEF DESCRIPTION OF THE DRAWINGS

FIG. 1A depicts block diagram of a computing environment, in accordance with one embodiment of the present invention.

FIG. 1B depicts block diagram of a computing environment, in accordance with one embodiment of the present invention.

FIG. 2 depicts an image of an anti-fouling system application, in accordance with one embodiment of the present invention.

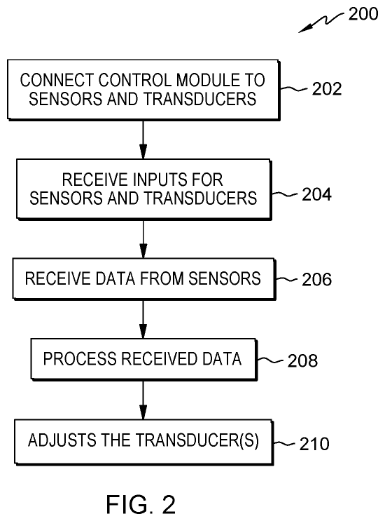

FIG. 3 depicts a diagram of a user interface showing the operation of the anti-fouling system, in accordance with one embodiment of the present invention.

FIG. 4 depicts a block diagram depicting the internal and external components of the server and computing device of FIGS. 1A and 1B, in accordance with one embodiment of the present.

### DETAILED DESCRIPTION OF THE INVENTION

The present invention provides a non-toxic, environmentally beneficial anti-fouling system that is self-monitoring and self-adjusting. The present invention may prevent the fouling organism from growing, reducing the growth rate of the fouling organisms, may remove the fouling organisms from the vessel or structure, or a combination of these. Aspects of the present invention improve the effectiveness and reliability of systems employing sound energy to reduce or prevent marine, brackish and freshwater fouling on submerged vessels and structures. This invention makes use of a systems approach to generate, monitor, and control sound pressure near and around the hull of the vessel and the submerged structures which are colonized by fouling organisms, by creating a vibrational energy field. This allows the submerged surface of a vessel or other submerged surface to remain free of fouling organisms in any aquatic environment.

The entire diverse and complex community of fouling organisms that settle and grow on ship surfaces, ranging from the tiniest micro-organisms (bacteria and algae) to the larger invertebrate larvae (barnacles, mussels, tunicates, bryozoans . . . etc.) can be targeted by delivering protective sound energy over the broad band of frequencies required to ensure maximum effectiveness on organisms differing widely in size. The sonic irradiations can be maintained continuously within optimum functional ranges for the entire suite of fouling community organisms with a concurrently operating monitoring, feedback, and adjustment system.

The present invention also provides the advantage of protecting submerged structures (e.g., pier pilings) from ship worms, barnacles, mussels, algae, and other fouling organisms. Through a modular and easily reconfigured system, the present invention provides an advantage of being highly customizable based on the intended application. The present approach entails the utilization of various sensors for controlling transducers or arrays of transducers. This provides for a system that maximizes the performances of the arrays of transducers to the greatest degree possible. Also, the inventive system can be used to keep water intake pipes of power plants and other operations free of serious pest organisms like zebra mussels (Dreissena polymorpha) which settle inside and outside the pipe the pipe, grow rapidly, and clog such pipes. The system can be used to kill the dispersal forms of fouling organisms universally contained in shipping vessel ballast tank water. This prevents the environmentally damaging introduction and spread of exotic, invasive fouling organisms to new waters when ballast water is released. Invasive species are now considered a major threat to the health of world ocean ecosystem stability and biodiversity.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

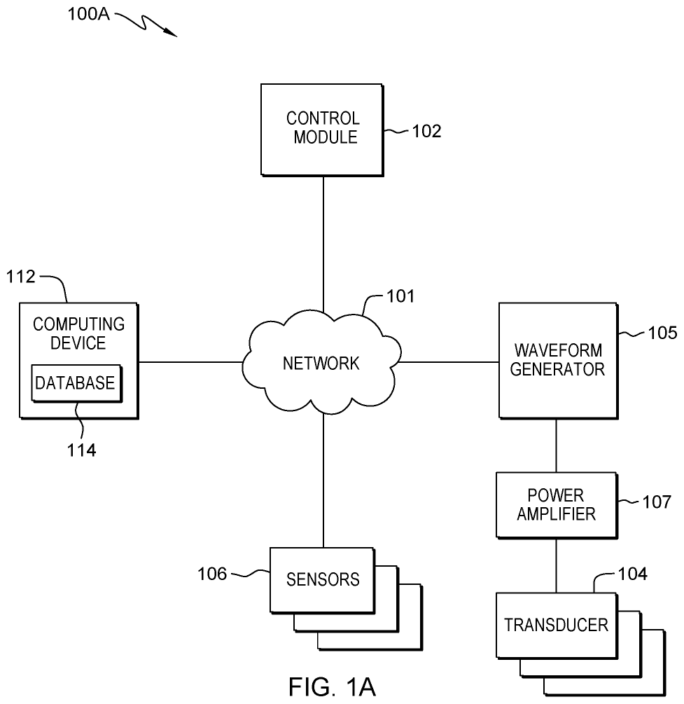

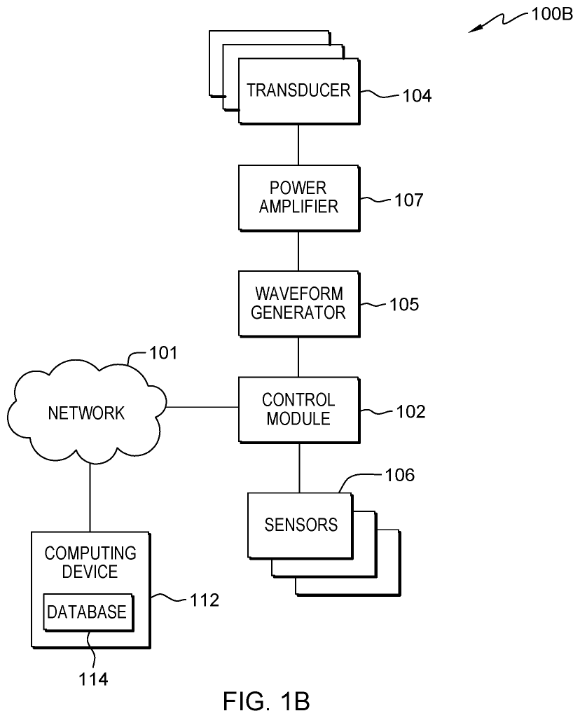

The present invention is disclosed in a first embodiment depicted in FIG. 1A, in accordance with one embodiment of the present invention. The system 100, is comprised of a network 101, a control module 102, at least one transducer 104, at least one sensor 106, a waveform generator 105, a power amplifier 107, and a computing device 112. In the depicted system 100 each component may have its own independent power source, the system may have a single power source, or a mixture of both may be employed.

The present invention is depicted in a second embodiment in FIG. 1B, wherein the control module 102, is connected in a private circuit with the waveform generator 105, the power amplifier 107, the transducer 104, and the sensor 106. The control module 102 is able to communicate with the computing device 112 via network 101. This is another embodiment, of the design of system 100.

Network 101 may be a local area network (LAN), a wide area network (WAN) such as the Internet, any combination thereof, or any combination of connections and protocols that can support communications between the computing device and the control module 102. Network 101 may include wired, wireless, fiber optic, or other forms of data exchanging connections. In other embodiments, the network 101 may represent a server computing system utilizing multiple computers as a server system, such as in a cloud computing environment. In another embodiment. In the depicted embodiment, the control module 102, the waveform generator 105, the power amplifier 107, the sensors 106, and the transducers 104 are all connected through a wired network. In additional embodiments, the control module 102, the waveform generator 105, the power amplifier 107, the sensors 106, and the transducers 104 may be connected by a local area network, such as but not limited to, Bluetooth® technology or other wireless networks.

The control module 102 controls and monitors the transducers 104 and analyzes the data collected by the sensors 106. The control module 102 monitors all aspects of the system and determines the mode of the system, e.g., active or standby based on the vessel speed and user request. The control module 102 processes the data collected by the sensors 106 to determine the optimum settings for the transducers 104. The control module 102 is able to adjust the transducers 104 based on the received data.

The control module 102 may be a standalone computing device or may be part of a computing system that provides the commands for the transducers 104 and processes the data collected by the sensors 106. The control module 102 may be a management server, a web server, or any other electronic device or computing system capable of processing program instructions and receiving and sending data. In other embodiments, the control module 102 may be a laptop computer, tablet computer, netbook computer, personal computer (PC), a desktop computer, or any programmable electronic device capable of communicating with the transducers 104 and the sensors 106 either directly (i.e., wired) or remotely (i.e., wirelessly). In other embodiments, control module 102 may be a server computing system utilizing multiple computers as a server system, such as in a cloud computing environment.

The transducers 104 are devices that are able to convert electrical waveforms into acoustic waves. The transducers 104, which can be constructed of piezoelectric transducers, of either ceramic crystalline type, or film organic material type. Each transducer 104 has the ability to vary the amplitude, frequency, volume, wave form, and sound-delivery pattern response, from approximately 20 kHz to about 50 kHz. Depending on the organisms (type, size, and settlement location), different sound waves may provide a more efficient and effective anti-fouling ability of the transducers 104. Through electrical impulses received from a wave form generator 105, the fluctuating voltage applied across the transducer 104 causes a crystal to expand and contract, which in turn causes oscillation at a frequency determined by the waveform generator 105. The crystal used in the transducer 104 may be but not limited to, berlinite, quartz, tourmaline, salt, and the like which would be acceptable to use in a submerged environment. This voltage fluctuation in turn produces a mechanical (e.g., up-and-down) vibration of a surface of the transducer 104, causing sound waves to propagate through the environment.

The mechanical sound waves travelling from the transducer 104 consist of moving bands of compressed fluid (high pressure) alternating with bands of rarified or expanded fluid (low pressure). If the pressure differential between the compressed and rarified zones is great enough and occurs rapidly enough (i.e., if the sound is “loud” enough and the frequency is high enough), cavitation occurs. Cavitation is the formation of micro-bubbles from dissolved gases in a travelling rarified fluid band of the sound wave, followed by rapid compression of the bubbles to the point of implosion by the compressed fluid band that comes after the rarified one. The imploding bubbles cause shock waves and violent molecular motion of air or water on a micro-scale. If cavitation occurs right at the surface of a solid submerged object (e.g., boat hull or submerged structure) the high energy shock waves and extreme micro-turbulence make it substantially impossible for fouling organisms (e.g., tiny barnacle larvae, microscopic algae spores) to attach. These oscillations may be subsonic, audible, ultrasonic, or mega sonic frequencies. The transducers 104 are able to be electronically steered similar to that of a phased array. Wherein the direction of the sound waves generated by the transducers 104 are shifted the phase of each transducer 104 to redirect the sound wave. In some embodiments, the transducers 104 have the ability to shift the sound wave 90 degrees from center. Wherein center is perpendicular to the forward face of the transducer 104. In embodiments, where the transducers 104 are able to be electronically steered, a phase shifter is integrated into the transducers 104 or may be incorporated as an independent component in the system 100.

The transducers 104 may be, but not limited to a piezoelectric ceramic transducer, or other types of transducers which are able to operate in a submerged environment. In some embodiments, the range of frequencies of the transducers 104 may be as low as 20 kHZ or as high as 1 MHz

The transducers 104 are designed to operate with a low voltage supply. In one embodiment, that is a voltage has a pike of a hundred (100) voltage or a root mean square voltage of approximately thirty-five (35) volts. In additional embodiments, the low voltage supply may be higher or lower based on the intended operation and size of the system 100. This low voltage provides the benefit of reducing operating energy demand, the risk of injury to humans or wildlife in the water, and also reduce the likelihood of damage to the vessel or the structure. The voltage of the transducers 104 is based on the electrical impedance of that transducer. The electrical impedance is determined by both the mechanical resistance presented to the transducer from its environment, e.g., materials on the transducer face, materials used to make a housing, whether it is operating in air or water or some other material such as the fiberglass of a boat hull, or epoxies or other adhesives use to make acoustic windows for a housing. In one embodiment, the transducers 104 are comprised of a transducer mounted (e.g., with epoxy) to a thin flexible diaphragm. The diaphragm with the transducer was then mounted in a housing that accommodates the exact size of the diaphragm on a “lip” and the diaphragm and transducer are sealed within the waterproof housing. In some embodiments, the diaphragm is one millimeter thick. In some embodiments, the transducers 104 produced an impedance of 200 Ohms to 500 Ohms with this low voltage.

The transducers 104 have a durable, water-proof housing, that has minimal impedance to the transmission of ultrasound through the fluid so that cavitation is induced at the target location. The direction and area of coverage of the transducer 104 is determined by the size, shape, contour, and overall design. Depending on the application various sizes of transducers 104 may be used.

Additionally, the design of the transducers 104 affects the distance at which the transducers 104 are operational. In one embodiment, the transducers 104 are designed to be effective at preventing fouling of the vessel or structure from one meter away.

In some embodiments, the transducers 104 are in an array formation, where multiple transducers 104 are used. The transducers 104 in the arrays may operate independently of one another or may operate as a single unit. In some embodiments the array formation is steerable and has additional components such as a motor to control the array formation to traverse the vessel or structure remotely. In some embodiments, the arrays are electronically steerable. This allows for the array to energize a large area via the mechanism of electronically sweeping the array focal point. In some embodiments, the transducers 104 are able to effectively prevent the fouling organisms from growing on the vessel or structure over an area of two square meters. Through the use of an array formation, and the ability to electronically steer the array of transducers 104, a greater area is able to be covered without the necessity to move the transducers 104.

The power amplifier 107 is designed to increase the power input signal received by the transducer 104. The power amplifier 107 increase the amplitude of the signal received by the waveform generator 105. Various types of power amplifiers 107 known in the art may be employed in the system 100. In some embodiments, each transducer 104 has a power amplifier 107. In additional embodiments, one power amplifier 17 may be used for a plurality of transducers 104. The power amplifier 107 is configured to amplify an input signal from a waveform generator 105 which is capable of generating various waveforms. The power amplifier 107 needs to able to provide at least a variable voltage output of between 5 and 45 root-means-square (RMS) voltage, with a current capability of at least 1000 milliamps (ma) into an impedance of at least 120 ohms. The power amplifier 107 may be class AB, C, D, provided it is able to reproduce and amplify the waveforms input from the waveform generator 105. The power amplifier 107 has an impedance matching network which is capable of matching the impedance of the waveform generator 105. In one embodiment, the power amplifier 107 is a power FET type amplifier, which have the capability of high output power with good linearity. In some embodiments, the power amplifier 107 is designed with sufficient heat removal features and designs, as well as a waterproof enclosure. The power amplifier 107 may be a single channel, multiple channels, or the ability to bridge two channels. This allows for greater power capability into high impedance loads.

A waveform generator 105 is used to control the functionality of the transducers 104. The waveform generator 105 generates different types of electrical waveforms over a wide range of frequencies which are received by the transducer 104 and produce the acoustic wave to match the received electrical waveform. The waveform generator 105 uses numeric sequences to define the desired output waveform and is able to produce a multitude of different waveforms. In one embodiment, the waveform generator 105 is able produce a various different wave patterns (e.g., sine wave, square wave, sawtooth wave, etc.) from 20 kHz to 60 kHz.

The sensors 106 are devices which are able to receive data and transfer the data to the control module 102. In one embodiment, the sensors 106 convert acoustic energy (generated by the transducers 104) into electrical voltage. The converted acoustic energy is then analyzed with an analog to digital converted to provide a reading of the acoustic energy impinging on the sensor 106. In additional embodiments, the sensors 106 are able to detect temperature, humidity, barometric pressure, global positioning, wind, the systems power, and the like.

Computing device 112 may be a management server, a web server, or any other electronic device or computing system capable of processing program instructions and receiving and sending data. In other embodiments, the computing device 112 may be a laptop computer, tablet computer, netbook computer, personal computer (PC), a desktop computer, or any programmable electronic device capable of communicating with control module 102 via network 102. In one embodiment, computing device 112 represents a computing system utilizing clustered computers and components to act as a single pool of seamless resources.

Database 114 may be accessed by control module 102. Information gathered from the sensors 106, the waveform generator 105, the control module 102, and the transducers 104 may be stored to database 114. In one embodiment, database 114 is a database management system (DBMS) used to allow the definition, creation, querying, update, and administration of a database(s). In the depicted embodiment, database 114 resides on computing device 112. In other embodiments, database 114 resides on another server, or another computing device, provided that database 114 is accessible to control module 102.

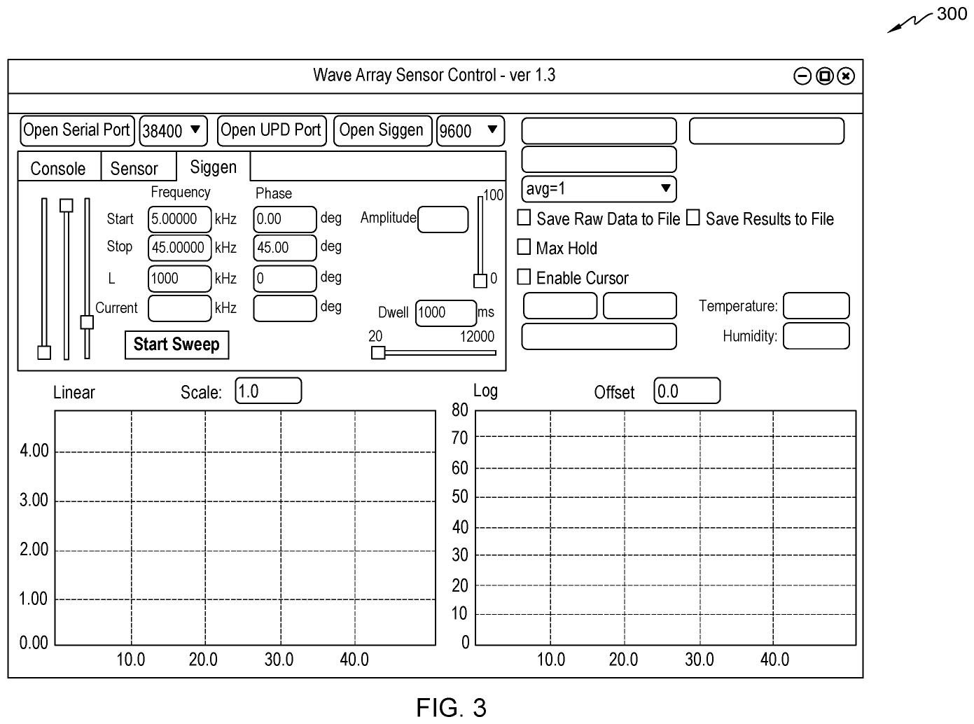

FIG. 3 depicts a flow diagram of the method of operation of the fouling system, in accordance with one embodiment of the present invention. The order or sequence of the process or method steps may be varied or re-sequenced according to alternative embodiments. Other substitutions, modifications, changes, and omissions may be made in the design, operating conditions and arrangement of the exemplary embodiments without departing from the scope of the present disclosure.

The limit of functionality of the remote monitoring is dependent upon the specific sensory hardware utilized in the system. Collected and measured information can include acoustic energy, voltage, current, temperature, visuals, humidity, weather alerts and other specialized properties when deemed necessary. For example, through the utilization of temperature monitoring or current monitoring one can determine if there is a detect in the system and can then turn the specific connected submersible housing off remotely to ensure that a safe environment is maintained.

In step 302, the control module 102 connects to each of the transducers 104 and the sensors 106 within the system. The control module 102 is able to detect the features and abilities of each device. This is related to the type of data which the sensor 106 can collect, the limitations and abilities of the transducers 104, and the integrated mounting systems (if present). The control module 102 connects with the user interface of the software to adjust the user interface based on the sensors 106 and the transducers 104, wherein the control module 102 is able to activate and deactivate various features of the software and the user interface.

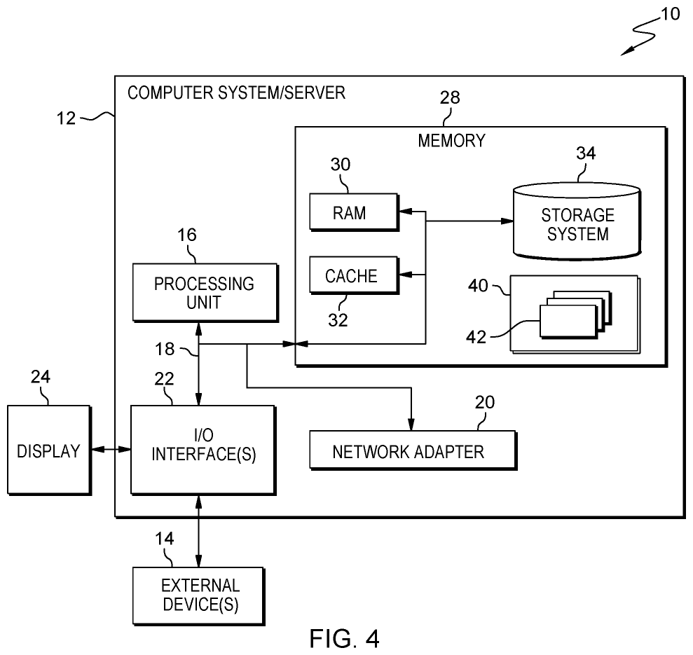

In step 304, the control module 102 receives the inputs provided by the operator. These inputs may be, as shown in FIG. 4, based on various features of the sensors 106 and transducers 104. Based on the user received inputs, the control module 102 may permit or deny the inputs if the limitations of the sensors 106 or the transducers 104 are extended or passed. In the depicted embodiment predetermined features of the sensors 106 and the transducers 106 are adjustable.

In step 306, the control module 102 activates a/the transducer(s) 104 once the system is activated either manually or automatically through the detection of the vessel or a predetermined event occurring. The transducers 104 may be activated at a standard frequency based on the type of transducer 104 and the location of the transducer 104 (e.g., internal or externally mounted) after an initial reading if performed by the sensors 106. In the user interface, visual depictions of the transducers 104 is available to be viewed based on the user interface setup.

In step 308, the control module 102 receives data from the sensor 106 associated with each active transducer 104. Data is accumulated by the sensors and the transducers and send this data related to the performance for analysis and interaction. The data will be organized with the user selected information to ensure operations are running as expected. Interested personnel can include boat owners, marina operators, and third-party technicians. For specialized circumstances, relevant information can be hand tailored for full marina analysis that includes multiple adaptive array systems as well as simply a single submersible housing configuration. The method of transmitting this data will make use of standard IOT protocols such as MQTT or COAP. See figure for an example of such a graphical user interface for monitoring and control. In some embodiments, if the transducer 104 is generating data which is outside of an operation range or operating in an ineffective range or setting. The control module 102 creates warnings or alerts to adjust the settings. In some embodiments, the control module 102 may automatically adjust the setting to be within the predefined range. This can be both to avoid damaging the transducers 104 as well as increase the efficiency of the transducers 104. The control module 102, is also about to detect the degradation of the sensors 106 or the transducers 104 based on changes in the data collected from, or values produced by the components. Based on the other transducers 104 and the readings these transducers 104 are producing, if values of a transducer 104 with a similar setup are changing, the control module 102 may indicate this as the transducer 104 is failing and needs to be replaced.

In step 310, the control module 102 analyzes the received data. This allows the control module 102 to constantly know how each transducer 104 is performing based on the data collected by the sensors 106.

In step 312, the control module 102 adjusts a/the transducer(s) 104 based on the received data to maintain a safe operation, a predetermined efficiency level, and a predetermined effective area so as to minimize the energy required by the system while maximizing the anti-fouling abilities of the system. This process is performed autonomously based on the present of a vessel within a predetermined proximity to the sensors 106. Once the vessel is identified by the sensor(s) 106, the transducers 104 which cover that “area” are activated based on the sensors 106 collected data. The adjustment of the transducer 104 may be necessary to maintain an area of effectiveness for the prevention of fouling. This is vital as the constant changing of the fluid's conditions require constant adjustment of the transducers 104 to effectively protect the vessel or structure from fouling organisms.

Various manual inputs can be made to control the system wirelessly. Through an interface such as this, one can control the voltage gains, the frequencies, the phase shifting and even beam forming dynamics if in use. This level of control and monitoring is crucial for both ensuring safe and efficient procedures. FIG. 3 depicts an exemplary embodiment of a user interface 300, in accordance with one embodiment of the present invention where the user is able to view the various inputs, sources of the data, collected data, and the ability to modify the equipment to achieve a desired result. This may also show various warnings and indicators of problems or equipment which is not performing to the predetermined specifications.

In some embodiments, the control module 102 is able to adjust the transducers 104 direction. Transducers employing beam steering technology can be used to direct energy to specific locations. By controlling the phase relationship of the excitation waveforms, the energy delivery (gain pattern) can be steered in specific directions. This beam steering can focus energy on specific locations or be used to sweep the energy over a desired coverage area. In some embodiments, if the user adjusts a setting, the control module 102 may adjust other settings of the transducer 104 or the sensor 106 to keep the component operating within a predetermined range so as to not cause damage to the components. In other embodiments, the adjustable aspects of the components are limited based on the component so that the component cannot be set to levels which could cause damage to them. This may be done by either limiting the ranges which the user can enter, or by creating alerts if the user enters a value which outside the predetermined operating range.

In additional embodiments, the control module 102 may detect stray electricity leaks into the fluid that may develop and consequently increase corrosion of boat metal parts (e.g., prop). If the electricity leak is detected the control module 102 may shut of the specific component or the entire system. Thus, an added feature of the monitoring part of system is corrosion protection.

By using a plurality of transducers 104 with a wide frequency response, the sweep and pulse patterns of sound delivery, the placement of the transducers 104, the use of sensors 106 to detect the sound energy and frequency being delivered to a given area of the vessel, or other structures, the use of control module 102 feedback analysis to measure and control the amplitude and frequency being delivered to various areas of the vessel, or other structures, the optimum frequency range and sound energy can be chosen to increase the effect, to the maximum prevention of fouling for a vessel or structure.

FIG. 4, computer system/server in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still, yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include but are not limited to: microcode, device drivers, redundant processing units, and external disk drive arrays, RAID systems, tape drives, and data archival storage systems, etc.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

The present invention has been described in the foregoing on the basis of several preferred embodiments. Different aspects of different embodiments are deemed described in combination with each other, wherein all combinations which can be deemed by a skilled person in the field as falling within the scope of the invention on the basis of reading of this document are included. These preferred embodiments are not limitative for the scope of protection of this document. The rights sought are defined in the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A method of controlling an anti-fouling system, the method comprising:
activating, by one or more computing devices, at least one transducer and at least one sensor;
analyzing, by one or more computing devices, the at least one transducer and the at least one sensor to determine a set of features of the at least one transducer and the at least one sensor which are controllable;
generating, by one or more computing devices, a user interface, wherein the user interface is based on the set of features of the at least one transducer and the at least one sensor;
generating, by one or more computing devices, a sound wave from the at least one transducer based on input data;
monitoring, by one or more computing devices, the performance of the transducer by collecting data from the at least one sensor; and
providing, by one or more computing devices, the collected data through the user interface, wherein values outside of a predetermined range, further comprise, transmitting, by one or more computing devices, an indicator of the values.

2. The method of claim 1, wherein the generating of the user interface, further comprises, deactivating, by one or more computing devices, controls which are not features of the at least one transducer.

3. The method of claim 1, further comprising, modifying, by one or more computing devices, values of the at least one transducer based on limitations of the transducer.

4. The method of claim 1, further comprising, manipulating, by one or more computing devices, the value of the at least one transducer which is outside the predetermined range.

5. The method of claim 1, further comprising, detecting, by one or more computing devices, degradation of the at least one transducer based on the performance of the at least one transducer, wherein a warning is generated.

6. The method of claim 5, further comprising, activating, by one or more computing devices, a predetermined setting of the at least one transducer when a determination of degradation is achieved.

7. A computer program product for controlling an anti-fouling system, the method comprising:
the computer program product comprising a computer readable storage medium having program instructions embodied therewith, the program instructions executable by a computing device to cause the computing device to:
program instructions to activate at least one transducer and at least one sensor;
program instructions to analyze the at least one transducer and the at least one sensor to determine a set of features of the at least one transducer and the at least one sensor which are controllable;
program instructions to generate a user interface, wherein the user interface is based on the set of features of the at least one transducer and the at least one sensor;
program instructions to generate a sound wave from the at least one transducer based on input data;
program instructions to monitor the performance of the transducer by collecting data from the at least one sensor; and
program instructions to provide the collected data through the user interface, wherein values outside of a predetermined range, further comprise, transmitting, by one or more computing devices, an indicator of the values.

8. The computer program product of claim 7, wherein the generating of the user interface, further comprises, program instructions to deactivate controls which are not features of the at least one transducer.

9. The computer program product of claim 7, further comprising, program instructions to modify values of the at least one transducer based on limitations of the transducer.

10. The computer program product of claim 7, further comprising, program instructions to manipulate the value of the at least one transducer which is outside the predetermined range.

11. The computer program product of claim 7, further comprising, program instructions to detect degradation of the at least one transducer based on the performance of the at least one transducer, wherein a warning is generated.

12. The computer program product of claim 11, further comprising, program instructions to activate a predetermined setting of the at least one transducer when a determination of degradation is achieved.

13. A system for controlling an anti-fouling system, the method comprising:
a CPU, a computer readable memory and a computer readable storage medium associated with a computing device;
program instructions to activate at least one transducer and at least one sensor;
program instructions to analyze the at least one transducer and the at least one sensor to determine a set of features of the at least one transducer and the at least one sensor which are controllable;
program instructions to generate a user interface, wherein the user interface is based on the set of features of the at least one transducer and the at least one sensor;
program instructions to generate a sound wave from the at least one transducer based on input data;
program instructions to monitor the performance of the transducer by collecting data from the at least one sensor; and
program instructions to provide the collected data through the user interface, wherein values outside of a predetermined range, further comprise, transmitting, by one or more computing devices, an indicator of the values.

14. The system of claim 13, wherein the generating of the user interface, further comprises, program instructions to deactivate controls which are not features of the at least one transducer.

15. The system of claim 13, further comprising, program instructions to modify values of the at least one transducer based on limitations of the transducer.

16. The system of claim 13, further comprising, program instructions to manipulate the value of the at least one transducer which is outside the predetermined range.

17. The system of claim 13, further comprising, program instructions to detect degradation of the at least one transducer based on the performance of the at least one transducer, wherein a warning is generated.

18. The system of claim 17, further comprising, program instructions to activate a predetermined setting of the at least one transducer when a determination of degradation is achieved.
